(19) United States
(12) Patent Application Publication
(10) Pub. No.: US 2013/0314757 A1
(43) Pub. Date: Nov. 28, 2013

(54) WAVELENGTH-CHANGEABLE LASER APPARATUS AND TUNING METHOD USING THE SAME

(71) Applicant: KOH YOUNG TECHNOLOGY INC., Seoul (KR)

(72) Inventors: Jang Il SER, Gapyeong-gun (KR); Jung HUR, Bucheon-si (KR); Moon-Young JEON, Seoul (KR); Hong-Min KIM, Seoul (KR); Sang-Kyu YUN, Chungju-si (KR); Jong-Kyu HONG, Gwangju-si (KR)

(21) Appl. No.: 13/900,365

(22) Filed: May 22, 2013

(30) Foreign Application Priority Data
May 22, 2012 (KR) 10-2012-0054476
May 16, 2013 (KR) 10-2013-0055431

(51) Int. Cl. G02B 26/10; F21V 13/12

(52) U.S. Cl. CPC G02B 26/105; F21V 13/12
USPC 359/212.2; 362/259

(57) ABSTRACT

A wavelength-changeable laser apparatus including a laser light source, a collimating lens, a diffraction grating, and a mirror is shown. The laser light source provides a laser light. The collimating lens collects the laser light provided from the laser light source and providing a light that is substantially parallel. The diffraction grating diffracts the light provided from the collimating lens. The mirror reflects the light provided from the diffraction grating back to the diffraction grating, a rotation axis rotatable within a predetermined range of a tuning angle being set therein so that a wavelength of the laser light is changed in a mode hopping form, the minor rotating based on the rotation axis serving as a pivot point. Therefore, a wavelength change speed may be increased and a stability of wavelength change may be improved.

### CROSS REFERENCE TO RELATED APPLICATION

This application claims priority from and the benefit of Korean Patent Application No. 10-2012-0054476 filed on May 22, 2012 and Korean Patent Application No. 10-2013-0055431 filed on May 16, 2013, which are both hereby incorporated by reference for all purposes as if fully set forth herein.

### BACKGROUND OF THE INVENTION

1. Field of the Invention

Exemplary embodiments of the present invention relate to a wavelength-changeable laser apparatus and a tuning method using the same, and more particularly the exemplary embodiments of the present invention relate to a wavelength-changeable laser apparatus based on an external resonator having a laser diode, a collimating lens, a diffraction grating, and a mirror, which changes a wavelength of output light in a specific range by reflecting laser light provided from laser diode with mirror and feeding back to the semiconductor resonator and a tuning method using the same.

2. Discussion of the Background In general, a wavelength-changeable semiconductor laser source should have a narrow line-width and a wide wavelength-changeable characteristic according to an operation range, to provide a continuous wavelength-change without a mode hopping in a changeable-wavelength range.

An external resonating wavelength-changeable laser diode has an advantage of having a wide and continuous wavelength-changeable characteristic, a narrow line-width characteristic, a high side mode suppression ratio (SMSR), etc. in comparison with a distributed bragg reflector using a sampled diffraction grating, especially in case of an external resonator of a Littman type, has a merit that a direction of the output light does not change in changing a wavelength to obtain a good directivity.

In the external resonator of a Littman type, light provided from a laser diode is collected by a lens to be provided to a diffraction grating facing the laser diode, and an angle and a size of a diffracted light for each order is determined according to a wavelength, an incident angle and a period of the diffraction grating, of the provided light. A 0-th order diffracted light through the diffraction grating is collected via a lens at an output end to externally exit, and a +1st order diffracted light is reflected again by a piezo-driving typed reflection minor to feed back to the laser diode. That is, when the reflection mirror is moved, only a wavelength of the +1st order diffracted light, which is perpendicularly incident onto the minor face among the wavelengths of the light exiting the laser diode, is selectively fed back to the laser diode. In the above-described process, the reflection minor is rotated to change the angle of the +1st order diffracted light of the light perpendicular to the minor face, thereby obtaining an effect that a wavelength of the incident light for the same incident angle changes according to the diffraction principle.

In the conventional Littman type, in order to obtain linearity of changeable wavelength, a lens, a diffraction grating and a mirror are installed by respectively forming a predetermined angle regarding a pivot point serving as a center, which is located apart from the lens, the diffraction grating and the mirror, and the mirror is featured to be rotatable on the pivot point serving as a center when driving the minor to change the wavelength. In case of a method of rotating a mirror on a pivot point serving as a center like this, stability of speed and stability of wavelength change may be deteriorated according to mechanical vibration in driving the minor.

### SUMMARY OF THE INVENTION

Exemplary embodiments of the present invention provide a wavelength-changeable laser apparatus applied to a measurement apparatus and capable of improving a tuning speed and a stability of wavelength change.

Exemplary embodiments of the present invention also provide a method of tuning a wavelength-changeable laser apparatus capable of improving a tuning speed and stability of wavelength change.

A wave length-changeable laser apparatus includes a laser light source providing a laser light, a collimating lens collecting the laser light provided from the laser light source and providing a light that is substantially parallel, a diffraction grating diffracting the light provided from the collimating lens, and a mirror reflecting the light provided from the diffraction grating back to the diffraction grating, a rotation axis rotatable within a predetermined range of a tuning angle being set therein so that a wavelength of the laser light is changed in a mode hopping form, the minor rotating based on the rotation axis serving as a pivot point.

For example, a normal line of the diffraction grating and a normal line of the mirror form a diffraction angle that exceeds a predetermined critical value.

The critical value of the diffraction angle may be formed by the normal line of the diffraction grating and the normal line of the mirror is set by at least one of an outer resonance mode interval of the laser, a pitch interval of the diffraction grating, and a rotation error of the mirror.

The diffraction angle formed between the normal line of the diffraction grating and the normal line of the mirror may be set according to a mathematical equation as below.

$$β > {cos}^{- 1} \frac{Δ λ}{d Δ β}$$

(wherein β is the diffraction angle formed by the normal line of the diffraction grating and the normal line of the mirror, Δλ is the outer resonance mode interval of the laser, d is the pitch interval of the diffraction grating, and Δβ is the rotation error of the mirror)

The tuning angle may be set so that a wavelength-changeable characteristic of the laser frequency have linearity not less than a first tolerance, and have a rate of change of wavelength to angle not greater than a second tolerance.

For example, the tuning angle maybe in a range of about 4 degree to about 19 degree.

For example, the mirror may include a galvano mirror.

A method of tuning a wavelength-changeable laser apparatus includes determining a changeable wavelength range of a laser frequency, determining a tuning angle of a galvano mirror according to the changeable wavelength range of the laser frequency, and determining a diffraction angle formed by a normal line of a diffraction grating and a normal line of the galvano mirror.

In determining a diffraction angle formed by a normal line of a diffraction grating and a normal line of the galvano mirror, the diffraction angle formed by the normal line of the diffraction grating and the normal line of the mirror may be set to exceed a predetermined critical value that is set by at least one of an outer resonance mode interval of the laser, a pitch interval of the diffraction grating, and a rotation error of the galvano mirror.

For example, the critical value is set according to a mathematical equation as below.

$$β > {cos}^{- 1} \frac{Δ λ}{d Δ β}$$

(wherein, β is the diffraction angle formed between the normal line of the diffraction grating and the normal line of the mirror, Δλ is the outer resonance mode interval of the laser, d is the pitch interval of the diffraction grating, and Δβ is the rotation error of the galvano mirror)

The method may further include correcting a changeable wavelength characteristic of the laser frequency to be linear.

In correcting a changeable wavelength characteristic of the laser frequency to be linear, the changeable wavelength characteristic of the laser frequency may be controlled to be linear by finely controlling a rotation angle of the galvano mirror for changing a frequency.

In determining a tuning angle of a galvano minor according to the changeable wavelength range of the laser frequency, the tuning angle may be set so that a wavelength-changeable characteristic of the laser frequency have a linearity not less than a first tolerance, and have a rate of change of wavelength to angle not greater than a second tolerance.

For example, the tuning angle may be in a range of about 4 degree to about 19 degree.

According to a wavelength-changeable laser apparatus of the present invention provides a diffraction angle may be set by considering outer resonance mode interval of laser, rotation error of galvano minor, and pitch interval of the diffraction grating, etc., regardless of the fixed pivot point located outside, to increase a wavelength change speed and improve a stability of wavelength change.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram briefly illustrating a wavelength-changeable laser apparatus according to an embodiment of the present invention.

FIG. 2 is a graph illustrating an output wavelength of a wavelength-changeable laser apparatus of FIG. 1.

FIG. 3 is a flow chart illustrating a tuning method of a wavelength-changeable laser apparatus according to other embodiment of the present invention.

FIG. 4 is a plurality of graph illustrating a tuning wavelength characteristic of a laser frequency according to a tuning angle of a galvano minor.

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

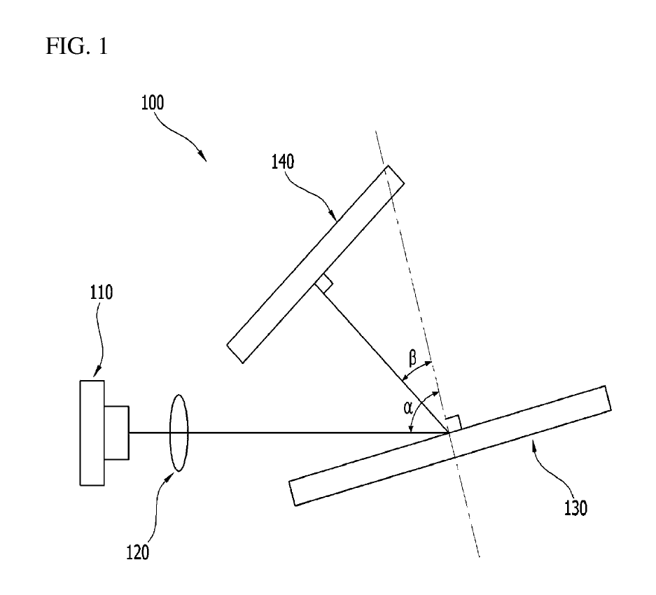

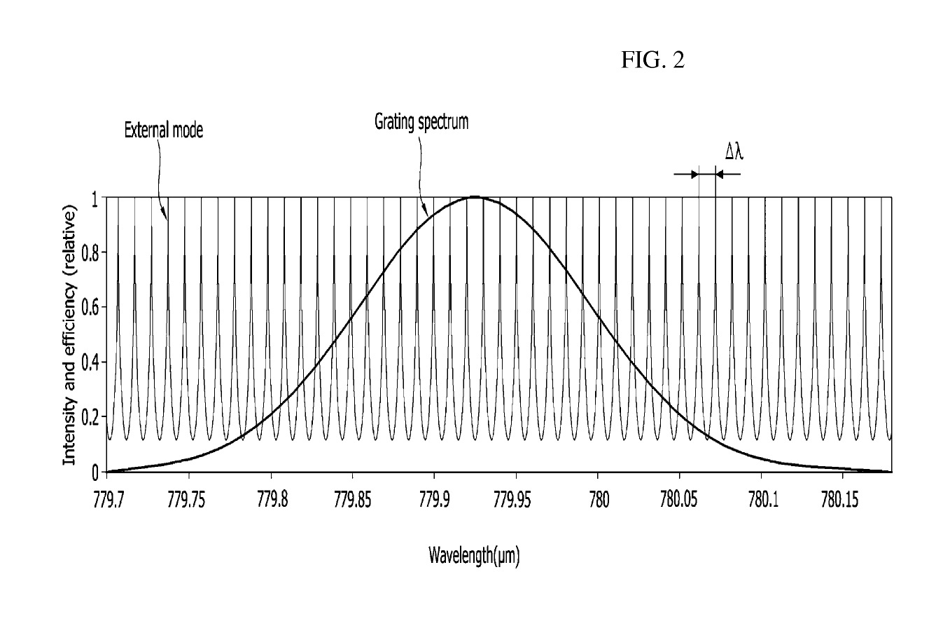

FIG. 1 is a block diagram briefly illustrating a wavelength-changeable laser apparatus according to an embodiment of the present invention. FIG. 2 is a graph illustrating an output wavelength of a wavelength-changeable laser apparatus of FIG. 1.

Regarding to FIG. 1 and FIG. 2, a wavelength-changeable laser apparatus 100 according to an embodiment of the present invention includes a laser diode 110, collimating lens 120, a diffraction grating 130, and a mirror 140.

The laser diode 110 provides a laser light, and the laser light provided from the laser diode 110 is provided to the collimating lens 120. The collimating lens 120 collects the laser light provided from the laser diode 110 and provides a light that is substantially parallel, the light that is substantially parallel provided from the collimating lens 120 is provided to the diffraction grating 130. The diffraction grating 130 diffracts the light provided from the collimating lens 120. The mirror 140 reflects the light that is provided from the diffraction grating 130.

A first diffraction light by the diffraction grating 130 is reflected back to the diffraction grating 130 by the mirror 140 and is reflected by the diffraction grating 130 so that only a specific wavelength is provided back to the laser diode 110. After the process is repeated a plurality of times, the light having specific wavelength is amplified by the laser diode 110, and the first diffraction light, in other words, the light reflected by the diffraction grating 130 is final output of the wavelength-changeable laser apparatus 100. The wavelength being output is changed according to the angle of the mirror 140.

Meanwhile, the wavelength-changeable laser apparatus 100 according to the present invention may serve as a tunable laser applied in a frequency scanning interferometry (FSI) measurement apparatus to inspect an inspection target such as a printed circuit board etc. The FSI measurement apparatus does not always require a linearity of changeable wavelength. However, it is more important to increase a change speed of wavelength and increase a stability of wavelength change in order to increase measurement efficiency.

Therefore, the wavelength-changeable laser apparatus 100 according to the present invention is a tunable laser applied in a FSI measurement apparatus, to increase wavelength change speed and stability of wavelength change. The wavelength-changeable laser apparatus 100 includes the mirror 140 that rotates based on a rotation axis serving as a pivot point, and the rotation axis is set to rotate within a predetermined range of a tuning angle so that a wavelength of the laser light is changed in a mode hopping form.

For example, the minor 140 may include a galvano-mirror that changes a wavelength in a mode hopping form as in FIG. 2.

A characteristic of the output wavelength is decided by how an angle of the minor 140 is controlled. Therefore, an embodiment of the present invention uses a galvano mirror having a wide wavelength changeable range and quick change speed instead of a conventional piezoelectric (PZT) minor having narrow wavelength changeable range and slow change speed, to increase a wavelength change speed. The galvano minor has a mirror attached to a galvano motor, and changes the galvano motor with a predetermined angle and a predetermined velocity.

In the wavelength-changeable laser apparatus 100 according to the present invention, considering a linearity of wavelength change, a diffraction angle β formed by a normal line of the diffraction grating 130 and a normal line of the galvano mirror 140 is set considering stability of wavelength change, which differs from the conventional apparatus adjusting disposition of a collimating lens 120, a diffraction grating 130, and a mirror 140 to a fixed pivot point located apart from a distance from the collimating lens 120, the diffraction grating 130, and the mirror 140,.

The stability of wavelength change is affected by a rotation error Δβ of the galvano mirror 140 and an outer resonance mode interval Δλ of the laser. The rotation error Δβ of the galvano mirror 140 is a fixed value decided by summing an instrument error of the galvano minor 140 and a precision control maximum tolerance. The outer resonance mode interval Δλ includes a tolerance of wavelength.

Therefore, the diffraction angle β formed by the normal line of the diffraction grating 130 and the normal line of the galvano mirror 140, is set to exceed a predetermined critical value by considering the outer resonance mode interval Δλ of the laser, the rotation error Δβ of the galvano mirror 140, and the pitch interval d of the diffraction grating 130, etc. For example, the diffraction angle β is determined by a mathematical equation I as below.

$$β > {cos}^{1} \frac{Δ λ}{d Δ β} \qquad Mathematical Equation I$$

The diffraction angle β is formed by the normal line of the diffraction grating 130 and the normal line of the galvano mirror 140, the outer resonance mode interval of the laser is Δλ, the rotation error of the galvano mirror 140 is Δβ, and the pitch interval of the diffraction grating 130 is d.

The diffraction angle β formed by the normal line of the diffraction grating 130 and the normal line of the galvano mirror 140 may be set by considering the outer resonance mode interval Δλ of the laser, the rotation error Δβ of the galvano mirror 140, and the pitch interval d of the diffraction grating 130, etc., regardless of the fixed pivot point located outside, to increase a wavelength change speed and improve a stability of wavelength change.

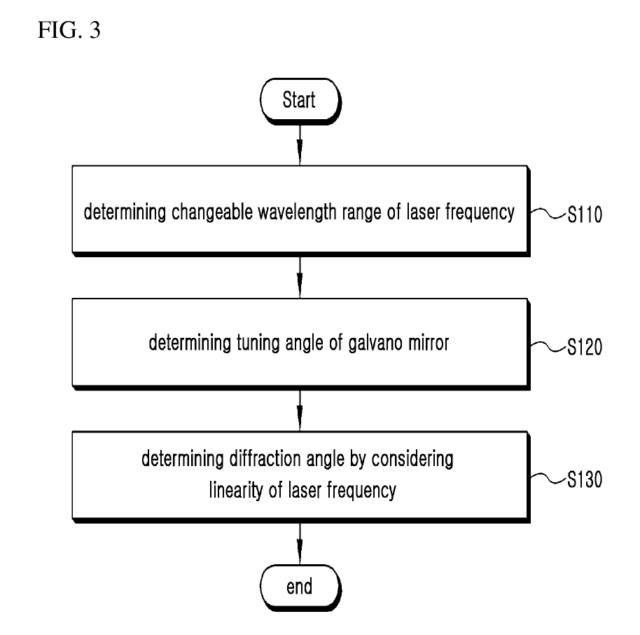

FIG. 3 is a flow chart illustrating a tuning method of a wavelength-changeable laser apparatus according to other embodiment of the present invention.

Regarding to FIG. 1 and FIG. 3, in order to set the diffraction angle β formed by the normal line of the diffraction grating 130 and the normal line of the galvano mirror 140, first, a changeable wavelength range of the laser frequency is determined as in step of S110.

Then, a tuning angle of the galvano mirror 140 according to the changeable wavelength range of the laser frequency is determined as in step of S120, and the diffraction angle β formed by the normal line of the diffraction grating 130 and the normal line of the galvano mirror 140 is determined by considering a linearity of changeable frequency wavelength characteristic in a changeable wavelength range of the laser frequency as in step of S130. In other words, the diffraction angle β formed by the normal line of the diffraction grating 130 and the normal line of the galvano mirror 140 may be set by considering the tuning angel of the galvano mirror 140 and the linearity of changeable frequency wavelength characteristic of the laser frequency.

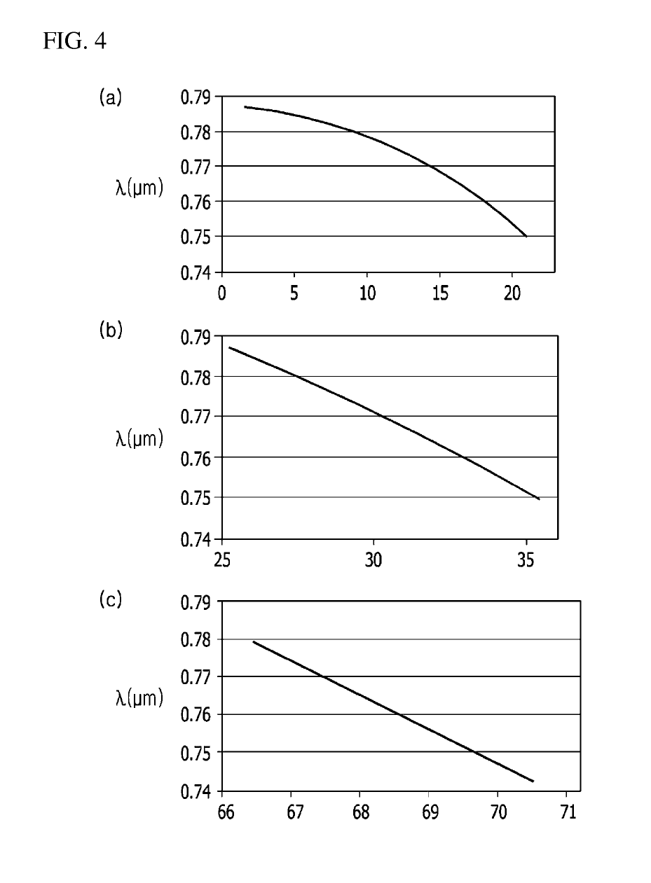

FIG. 4 is a plurality of graph illustrating a tuning wavelength characteristic of a laser frequency according to a tuning angle of a galvano minor. Regarding to FIG. 4, the tuning angle is 19° in (a), the tuning angle is 10° in (b), and the tuning angle is 4° in (c). The horizontal axis shows ‘90°—diffraction angle’ and vertical axis shows wavelength (μm).

Regarding to FIG. 1 and FIG. 4, the tuning angel of the galvano minor 140 set at 19° in the changeable wavelength range of the laser frequency as in (a), shows that the changeable wavelength characteristic of the laser frequency is not linear but irregular. In other words, when the tuning angle of the galvano mirror 140 is too large, the frequency wavelength may not show predetermined interval and occur mode hopping in an irregular interval.

Meanwhile, referring to (b) and (c) having the tuning angle of the galvano mirror 140 smaller than 19°, the changeable wavelength characteristic of the laser frequency has a good linearity as the tuning angle of the galvano mirror 140 becomes smaller. Especially, when the tuning angle of the galvano minor 140 is set at 4° as in (c), the changeable wavelength characteristic of the laser frequency shows linearity near to a straight line.

However, when the tuning angle of the galvano mirror 140 is too small, in dividing and scanning the changeable wavelength range of the same range by the same times, a rotation angle of one time becomes smaller, to thereby increase sensibility of wavelength-change and decrease stability of wavelength-change.

In conclusion, the tuning angle of the galvano minor 140 is set so that a wavelength-changeable characteristic of the laser frequency has a linearity not less than a first tolerance, and has a rate of change of wavelength to angle not greater than a second tolerance.

In addition, the diffraction angle β formed by the normal line of the diffraction grating 130 and the normal line of the galvano mirror 140 is set by considering the tuning angle of the galvano mirror and the changeable wavelength characteristic of the laser frequency, and also the stability of wavelength-change is preferred to be considered. In other words, wherein the critical value of the diffraction angle β formed by the normal line of the diffraction grating 130 and the normal line of the galvano mirror 140 is set by considering such as an outer resonance mode interval of the laser, a rotation error of the galvano mirror 140, etc., to increase the stability of the wavelength-change. The setting of the diffraction angle β considering stability of wavelength-change is described in the previous exemplary so the overlapped description will be omitted.

Thus, the tuning angle of by considering the tuning angle of the galvano mirror 140, the linearity of the changeable wavelength characteristic of the laser frequency, and the stability of the wavelength-change, the tuning angle of the galvano mirror 140 is set in a range about 4 degree to about 19 degree, for example, about 10 degree, and the diffraction angle β may be set about 59 degree.

Meanwhile, regarding to FIG. 4(b), when the changeable wavelength characteristic of the laser frequency shows little linearity, the changeable wavelength characteristic of the laser frequency may be corrected to be linear. In other words, the changeable wavelength characteristic of the laser frequency is controlled to be linear by finely controlling the rotation angle of the galvano mirror 140 for changing a frequency.

In conclusion, the diffraction angle β is set by considering the tuning angle of the galvano mirror 140, the linearity of the changeable wavelength characteristic, and the stability of the wavelength-change, to increase a tuning reliability of the wavelength changeable laser apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A wavelength-changeable laser apparatus, comprising:
a laser light source providing a laser light;
a collimating lens collecting the laser light provided from the laser light source and
providing a light that is substantially parallel;
a diffraction grating diffracting the light provided from the collimating lens; and
a mirror reflecting the light provided from the diffraction grating back to the diffraction grating, a rotation axis rotatable within a predetermined range of a tuning angle being set therein so that a wavelength of the laser light is changed in a mode hopping form, the minor rotating based on the rotation axis serving as a pivot point.

2. The wavelength-changeable laser apparatus of claim 1, wherein a normal line of the diffraction grating and a normal line of the mirror form a diffraction angle that exceeds a predetermined critical value.

3. The wavelength-changeable laser apparatus of claim 2, wherein the critical value of the diffraction angle formed by the normal line of the diffraction grating and the normal line of the minor is set by at least one of an outer resonance mode interval of the laser, a pitch interval of the diffraction grating, and a rotation error of the mirror.

4. The wavelength-changeable laser apparatus of claim 3, wherein the diffraction angle formed between the normal line of the diffraction grating and the normal line of the mirror, is set according to a mathematical equation as below.
$$β > {cos}^{- 1} \frac{Δ λ}{d Δ β}$$
(wherein β is the diffraction angle formed by the normal line of the diffraction grating and the normal line of the mirror, Δλ is the outer resonance mode interval of the laser, d is the pitch interval of the diffraction grating, and Δβ is the rotation error of the mirror)

5. The wavelength-changeable laser apparatus of claim 1, wherein the tuning angle is set so that a wavelength-changeable characteristic of the laser frequency has a linearity not less than a first tolerance, and has a rate of change of wavelength to angle not greater than a second tolerance.

6. The wavelength-changeable laser apparatus of claim 1, wherein the tuning angle is in a range of about 4 degree to about 19 degree.

7. The wavelength-changeable laser apparatus of claim 1, wherein the mirror includes a galvano mirror.

8. A method of tuning a wavelength-changeable laser apparatus, comprising:
determining a changeable wavelength range of a laser frequency;
determining a tuning angle of a galvano minor according to the changeable wavelength range of the laser frequency; and
determining a diffraction angle formed by a normal line of a diffraction grating and a normal line of the galvano mirror.

9. The method of claim 8, in determining a diffraction angle formed by a normal line of a diffraction grating and a normal line of the galvano mirror,
wherein the diffraction angle formed by the normal line of the diffraction grating and the normal line of the galvano mirror is set to exceed a predetermined critical value that is set by at least one of an outer resonance mode interval of the laser, a pitch interval of the diffraction grating, and a rotation error of the galvano mirror.

10. The method of claim 9, wherein the critical value is set according to a mathematical equation as below.
$$β > {cos}^{- 1} \frac{Δ λ}{d Δ β}$$
(wherein, β is the diffraction angle formed between the normal line of the diffraction grating and the normal line of the galvano mirror, Δλ is the outer resonance mode interval of the laser, d is the pitch interval of the diffraction grating, and Δβ is the rotation error of the galvano minor)

11. The method of claim 8, further comprising;
correcting a changeable wavelength characteristic of the laser frequency to be linear.

12. The method of claim 12, in correcting a changeable wavelength characteristic of the laser frequency to be linear,
wherein the changeable wavelength characteristic of the laser frequency is controlled to be linear by finely controlling a rotation angle of the galvano mirror for changing a frequency.

13. The method of claim 8, in determining a tuning angle of a galvano mirror according to the changeable wavelength range of the laser frequency,
wherein the tuning angle is set so that a wavelength-changeable characteristic of the laser frequency has a linearity not less than a first tolerance, and has a rate of change of wavelength to angle not greater than a second tolerance.

14. The method of claim 13, wherein the tuning angle is in a range of about 4 degree to about 19 degree.
